(19) United States
(12) Patent Application Publication
(10) Pub. No.: US 2019/0056860 A1
(43) Pub. Date: Feb. 21, 2019

(54) INFORMATION PROCESSING DEVICE, INFORMATION PROCESSING METHOD AND PROGRAM STORING MEDIUM

(71) Applicant: NEC Corporation, Minato-ku, Tokyo (JP)

(72) Inventor: Yukari ISHIZUKA, Tokyo (JP)

(73) Assignee: NEC Corporation, Minato-ku, Tokyo (JP)

(21) Appl. No.: 16/078,119

(22) PCT Filed: Feb. 20, 2017
(86) PCT No.: PCT/JP2017/006065

§ 371 Date: Aug. 21, 2018

(30) Foreign Application Priority Data
Feb. 26, 2016 (JP) 2016-036277

(51) Int. Cl. G06F 3/0488; G06F 3/0482; H04M 1/02

(52) U.S. Cl. CPC G06F 3/04883; G06F 3/04817; H04M 1/0202; G06F 3/0482

(57) ABSTRACT

An information processing device includes: a display means for indicating an image; a display control means for making the display means display an input screen for inputting a sense of use; an operation means for accepting operation from a user; and a memory means for accumulating, taking the user having inputted a sense of use to the operation means in a state that the input screen is being indicated as a trigger, the sense of use having been inputted and environmental information indicating an information processing environment at the time of inputting the user's sense of use.

### TECHNICAL FIELD

The present invention relates to an information processing device, an information processing method and a program storing medium.

### BACKGROUND ART

In the technical field mentioned above, there is disclosed in patent literature 1 a technology which makes a user confirm sensory quality about a communication speed after presuming the quality. By this technology, matching of numerical values of radio field intensity and throughput to “easiness of connection” and “a network sensory speed” which a user actually feels is carried out.

### CITATION LIST

### Patent Literature

PTL 1: Japanese Patent Application Laid-Open No. 2014-165828

### SUMMARY OF INVENTION

### Technical Problem

However, in the technology described in the above-mentioned literature, a message is indicated just after the end of downloading a content so as to request input from a use. Accordingly, communication quality evaluation cannot be performed easily at user's desired timing.

The object of the present invention is to provide a technology which solves the above-mentioned issue.

### Solution to Problem

In order to achieve the above-mentioned object, a device according to the present invention is an information processing device including:

a display means for indicating an image;

a display control means for making the display means display an input screen for inputting a sense of use;

an operation means for accepting operation from a user; and

a memory means for accumulating, taking the user having inputted a sense of use to the operation means in a state that the input screen is being indicated as a trigger, the sense of use having been inputted and environmental information indicating an information processing environment at the time of inputting the user's sense of use.

In order to achieve the above-mentioned object, a method according to the present invention includes:

making a display means display an input screen for inputting a sense of use; and

accumulating, taking a user inputting a sense of use to an operation means in a state that the input screen is being indicated, the sense of use having been inputted and environmental information indicating an information processing environment at the time of inputting the user's sense of use.

In order to achieve the above-mentioned object, a program storing medium according to the present invention is a program storing medium storing a program to make a computer execute processing of:

making a display means display an input screen for inputting a sense of use; and

accumulating, taking a user inputting a sense of use to an operation means in a state that the input screen is being indicated, the sense of use having been inputted and environmental information indicating an information processing environment at the time of inputting the user's sense of use.

### Advantageous Effects of Invention

According to the present invention, a user can input sensory communication quality easily at desired timing, and a server can perform comparison between the bodily sensation and actual network communication quality.

### BRIEF DESCRIPTION OF DRAWINGS

FIG. 1 is a block diagram illustrating a structure of an information processing device according to a first example embodiment of the present invention.

FIG. 2 is a diagram illustrating a usage condition of a smart phone according to a second example embodiment of the present invention.

FIG. 3 is a diagram illustrating a screen example of a smart phone according to the second example embodiment of the present invention.

FIG. 4 is a function block diagram of a smart phone according to the second example embodiment of the present invention. 2

FIG. 5 is a flow chart illustrating a flow of processing of a smart phone according to the second example embodiment of the present invention.

FIG. 6 is a diagram illustrating a screen example of a smart phone according to a third example embodiment of the present invention.

FIG. 7 is a diagram illustrating a screen example of a smart phone according to a fourth example embodiment of the present invention.

FIG. 8 is a diagram illustrating a screen example of a smart phone according to a fifth example embodiment of the present invention.

### EXAMPLE EMBODIMENT

Below, example embodiments of the present invention will be described in detail exemplarily with reference to drawings. However, components indicated in the following example embodiments are just illustrations and the technological scope of the present invention is not limited to those.

### The First Example Embodiment

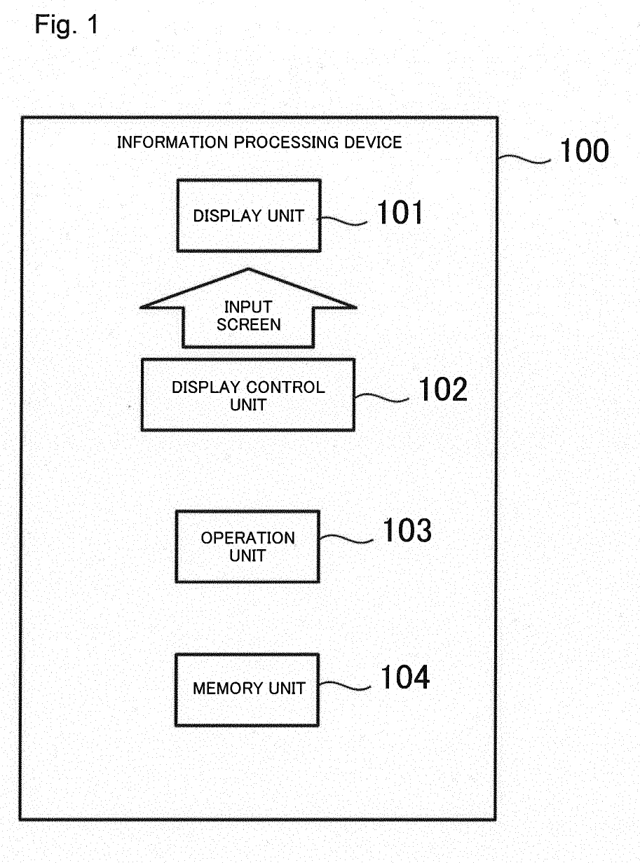

An information processing device 100 as the first example embodiment of the present invention will be described using FIG. 1. The information processing device 100 is a device such as a smart phone, a smart pad or the like which includes a display means and an operation means.

As indicated in FIG. 1, the information processing device 100 includes a display unit 101, a display control unit 102, an operation unit 103 and a memory unit 104.

The display unit 101 indicates an image, and the display control unit 102 makes the display unit 101 display an input screen for inputting a sense of use.

The operation unit 103 accepts operation from a user, and the memory unit 104 accumulates, taking the user having inputted a sense of use to the operation unit 103 in a state that the input screen is being indicated as a trigger, environmental information indicating the information processing environment at the time of inputting the sense of use of the user.

By the above mentioned structure, a user can evaluate a sense of use easily at desired timing, and the sense of use and the environment of an actual device can be associated.

### The Second Example Embodiment

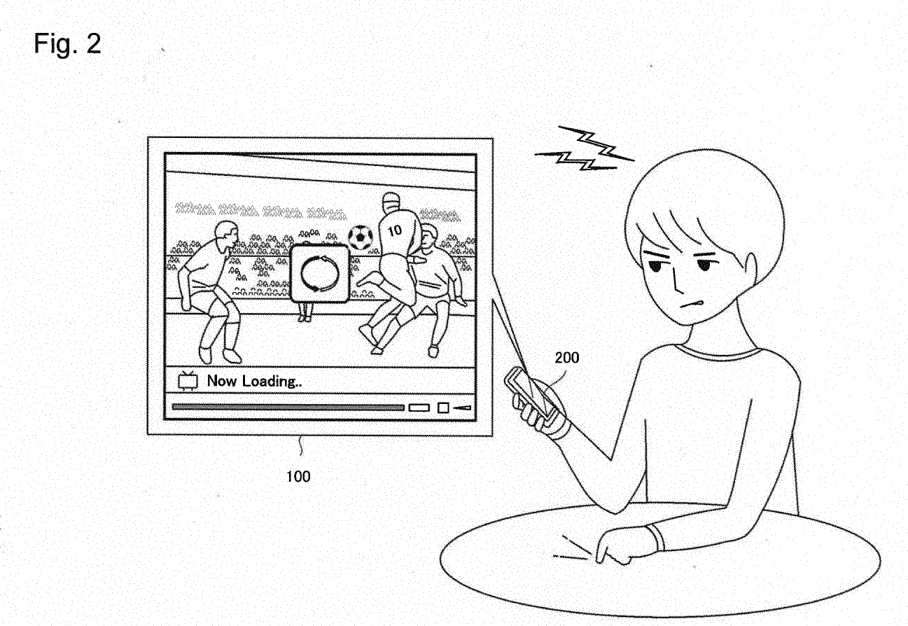

Next, an information processing device according to the second example embodiment of the present invention will be described using FIGS. 2 to 7. FIG. 2 is a diagram illustrating a situation when using a smart phone 200 as an example of an information processing device according to this example embodiment. Note that an information processing device of this example embodiment is not limited to a smart phone, and it can be applied to various portable communication terminals such as a tablet, a smart pad, a laptop computer, a mobile router and the like.

As illustrated in FIG. 2, there is often a case where a stress is felt due to such as stoppage of reproduction of an animation while viewing the animation using the smart phone 200. However, there is an issue that it is difficult for a user to accurately judge by what cause the operation of the smart phone 200 has stopped actually, and therefore the communication network provider cannot grasp clearly that by what kind of situation users feel a stress.

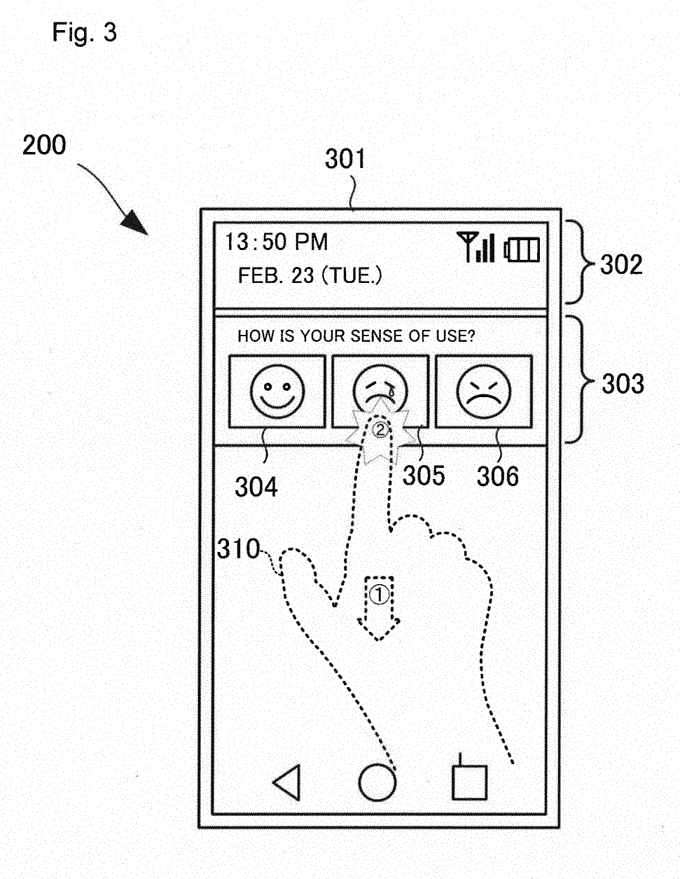

In such case, as illustrated in FIG. 3, an input screen 303 for a sense of use is indicated by performing slide by a downward flick operation (the circled 1 in FIG. 1) on a notification bar 302 which is in the upper part of a touch panel 301 and is an area for indicating date and time, antenna intensity, a battery remaining amount and the like.

Specifically, as the input screen 303, a plurality of icons (buttons) 304-306 representing user's sense of use are indicated. Here, although an example in which three buttons are displayed is illustrated, the present application is not limited to this, and the number of buttons for indicating dissatisfaction or satisfaction may be one or two, or no smaller than four.

When there are no problems regarding a sense of use, a user 310 taps the icon 304, when there is a problem of a sense of use a little, taps the icon 305 (the circled 2 in the figure), and, when there is a problem regarding a sense of use fairly, taps the icon 306. Simultaneously with the user having selected a sense of use, also the network quality as well as terminal information such as time and location information regarding the measurement environment and applications which the user is using and the like are acquired in the background. The network quality is a packet loss, a round trip time (Round-Trip Time: RTT) and a jitter (Jitter), for example. The time information on the measurement environment is the date and time when the information processing device 100 has measured the network quality. The location information on the measurement environment is a place where the information processing device 100 has measured the network quality. Although evaluation of network quality here may be performed inside the smart phone, an external measurement server for speed test only may be made to perform measurement. In such case, evaluations received from the measurement server are accumulated. When the establishment itself of communication with the measurement server has not been made, an evaluation as communication impossibility may be accumulated. By setting up items by which user's bodily sensation can be selected in the notification bar 302 in this way, an application for such as a speed test does not need to be started every time, and thus a user interface for reporting user's bodily sensation becomes simple. Even if the user is performing various kinds of operation on the screen, a sense of use can be inputted in the middle of the operation. Further, the speed test is a test for measuring the line speed/communication speed. Specifically, the speed test means a test to measure uplink and downlink transfer rates of a communication line (such as analog lines, IDSN lines, ADSL lines or optical lines) which is being used. Further, a network band measuring system disclosed in Japanese Patent Application Laid-Open No. 2011-142622, for example, can be used for the speed test.

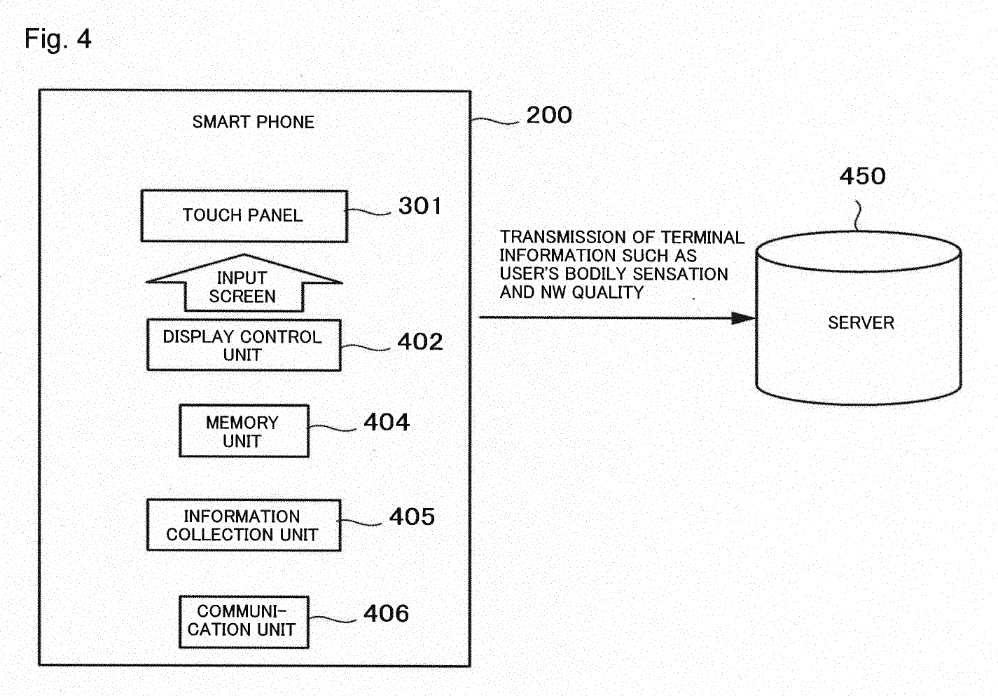

FIG. 4 is a function block diagram of the smart phone 200. The smart phone 200 includes the touch panel 301, a display control unit 402, a memory unit 404, an information collection unit 405 and a communication unit 406 as illustrated in the figure.

The touch panel 301 functions as a display means and an operation means. The touch panel 301 indicates an edit display on the occasion of text input, indicates a communication level, and indicates an execution screen of various applications. The touch panel 301 has a function to detect operation by a user's finger (or a touch pen). The smart phone 200 communicates with a base station (not shown) and a server 450 and the like, and houses various devices and the like for executing each application. The display control unit 402 generates an image for indicating on the touch panel 301.

The information collection unit 405 collects, in a manner taking a user having inputted a sense of use to the touch panel 301 as a trigger, the user's sense of use and environmental information, the environmental information indicating an environment of the terminal at the time of the input such as the input time of the sense of use, the network quality, the location information, and applications which have been being executed. Here, by a not-illustrated CPU (Central Processing Unit) executing a user's-sense-of-use collection application installed in the smart phone 200, the function of the information collection unit 405 is realized.

The memory unit 404 accumulates collected environmental information, and the communication unit 406 periodically transmits data accumulated in the memory unit 404 to the server 450. Environmental information should just include at least one of time, a location, network quality and an application which is being executed. Here, the time is time information on the above-mentioned measurement environment, and is the date and time when the information processing device 100 has measured the network quality. The location is location information on the above-mentioned measurement environment, and is a place where network quality has been measured by the information processing device 100. The communication unit 406 may immediately transmit environmental information which has been accumulated in the memory unit 404 taking a user having inputted a sense of use as a trigger. Alternatively, the communication unit 406 may transmit environmental information to the server 450 at timing of a good communication state after performing accumulation in the memory unit 404 for a fixed period. For example, there is a method to transmit environmental information only once a day or the like. Using environmental information collected from the smart phone 200, it becomes possible for the server 450 to visualize a degree of satisfaction of a user in a manner such as expressing a change in user's sense of use with time by mapping the user's sense of use on a map, and so on.

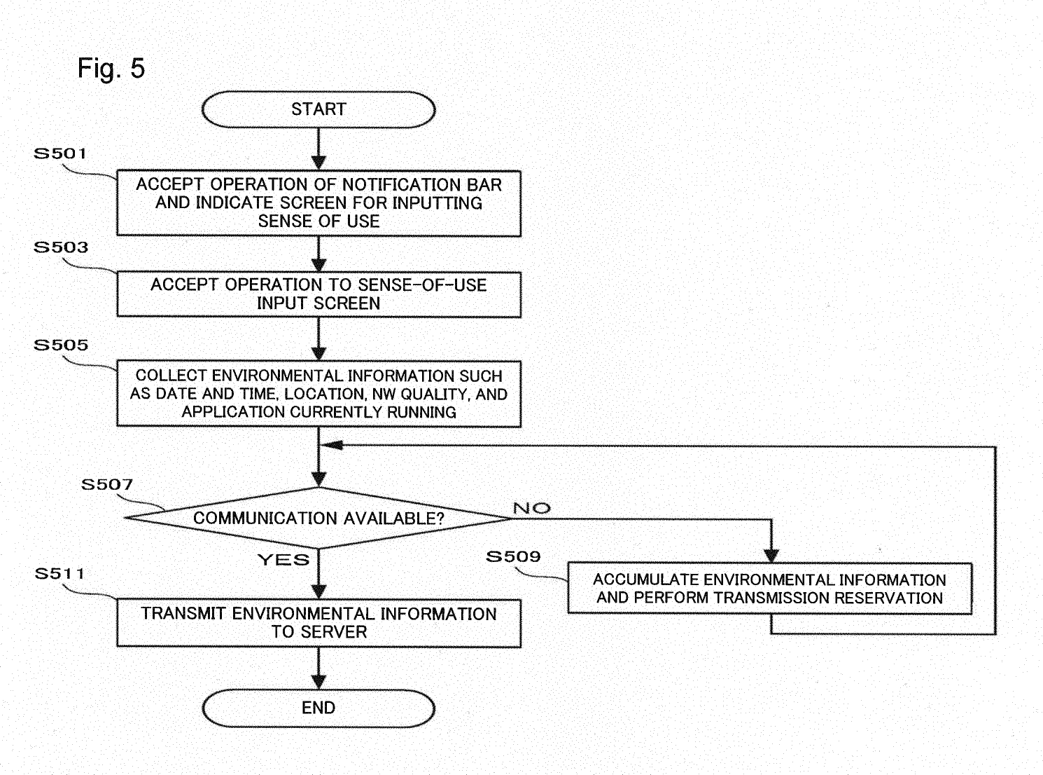

FIG. 5 is a flow chart illustrating a flow of processing of the smart phone 200. It is supposed that a user's-sense-of-use collection application stored in the smart phone 200 in advance is being carried out along with the activation of the smart phone 200.

In Step S501, when a downward slide is carried out on the notification bar 302 in a state that the notification bar 302 is being indicated, the input screen 303 for a sense of use is indicated.

When operation to the input screen 303 for a sense of use is accepted in Step S503, the processing advances to Step S505 triggered by the operation, and the user's-sense-of-use collection application collects information having an influence on user's sense of use. Specifically, the user's-sense-of-use collection application collects the evaluation itself of the sense of use and environmental information such as date and time, a location, network quality and other applications which are being executed. Here, the date and time is time information on the above-mentioned measurement environment, and is the date and time when the information processing device 100 has measured the network quality. The location is location information on the measurement environment, and is a place where the network quality has been measured by the information processing device 100. Note that the user does not need to recognize about the measurement and the collecting situations.

Next, the processing advances to Step S507, and the information processing device 100 determines whether communication with a server is possible. When communication with the server 450 is not available, the processing advances to Step S509, and the information processing device 100 stores the environmental information in a storage area temporarily and makes a transmission reservation. When determined that communication is available in Step S507, the processing advances to Step S511, and the information processing device 100 transmits the environmental information to the server 450. In other words, after being accumulated and packaged in the memory unit 104, environmental information is transmitted to the server 450 at predetermined timing. As a result, when the communication state is not good, environmental information is accumulated in the terminal for a fixed period, and the data will be transmitted to an accumulation server (the server 450) at timing when the communication state is recovered or the like.

In this example embodiment, a user interface through which user's bodily sensation can be inputted is set up in the notification bar area. As a result, when satisfaction/dissatisfaction about making use of a portable information device such as about network quality and the like is felt during operating other applications, a user can input user's bodily sensation without taking the trouble to start a dedicated application. Then, by acquiring device information such as network quality and the like at the moment of inputting user's bodily sensation taking the input as a trigger and gathering and storing such device information, relation between user's bodily sensation and an environment of the device can be analyzed more in detail.

In addition, by automatically collecting network quality and terminal information (time and location information on the measurement environment and applications being used by the user) in the background simultaneously with the user operation, more detail relation between user's bodily sensation and network quality and terminal information can be observed.

### The Third Example Embodiment

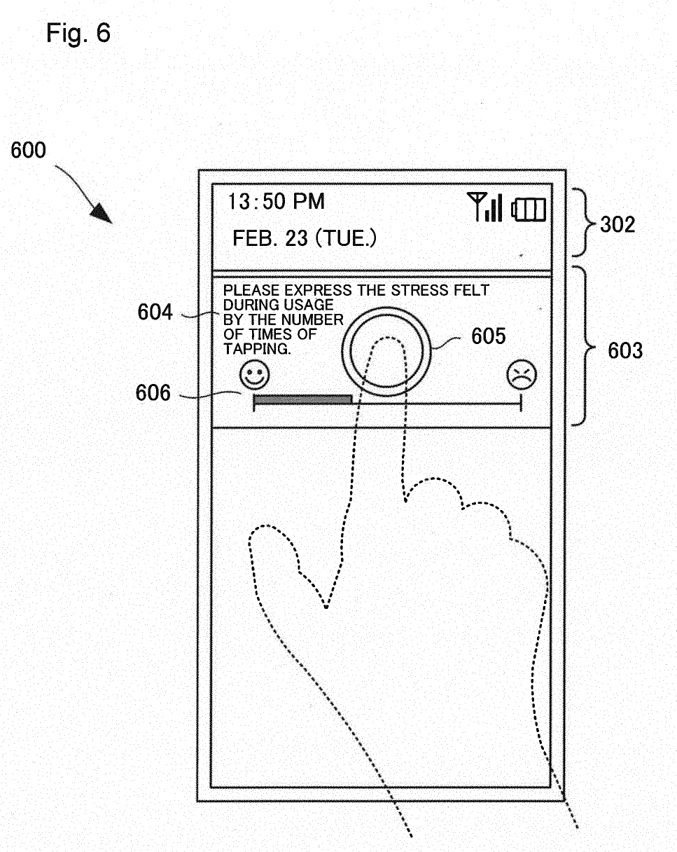

Next, a smart phone according to the third example embodiment of the present invention will be described using FIG. 6. FIG. 6 is a diagram illustrating a sense-of-use input screen of a smart phone according to this example embodiment. A smart phone 600 according to this example embodiment is different from a smart phone of the second example embodiment in a point that a sense of use is inputted using a difference in the number of times of tapping. Since the structures and operations other than that are similar to those of the second example embodiment, the same codes are attached to the same structures and the operations and detailed description will be omitted.

A button 605 which should be tapped and a message 604 that says “Please express the stress felt during usage by the number of times of tapping” are indicated on an input screen 603. When the button 605 is tapped repeatedly, the bar of a gauge 606 that represents a degree of dissatisfaction becomes long gradually. When tapping of the button 605 has not been performed for a while after the input, the input screen 603 is housed in the upper part of the screen. A user's-sense-of-use collection application collects information having an influence on the user's sense of use assuming that the input of the sense of use has become final. Specifically, the user's-sense-of-use collection application collects the evaluation itself of the sense of use, and environmental information on such as date and time, a location, network quality, other applications which are being executed and the like. Here, the date and time is time information on the measurement environment, and is the date and time when the information processing device 100 has measured the network quality. The location is location information on the measurement environment, and is a place where the information processing device 100 has measured the network quality.

According to this example embodiment, it is possible to accept the evaluation of user's sense of use according to an aspect different from that of the second exemplary embodiment.

### The Fourth Example Embodiment

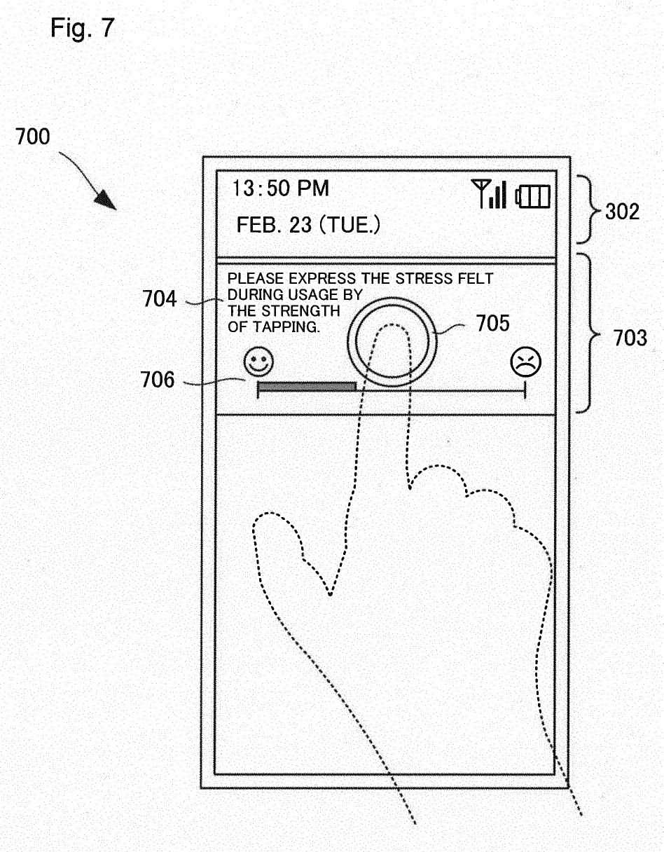

Next, a smart phone according to the fourth example embodiment of the present invention will be described using FIG. 7. FIG. 7 is a diagram illustrating a sense-of-use input screen of a smart phone according to this example embodiment. A smart phone 700 according to this example embodiment is different from a smart phone of the second example embodiment in a point that a sense of use is inputted using a difference in the strength of tapping. Since the structures and operations other than that are similar to those of the second example embodiment, the same codes are attached to the same structures and the operations and detailed description will be omitted.

A button 705 which should be tapped and a message 704 that says “Please express the stress felt during usage by the strength of tapping.” are indicated on an input screen 703. The harder taping of the button 705 is, the longer the bar of a gauge 706 that represents a degree of dissatisfaction is in proportion to the tapping strength. Further, a pressure sensor (not shown) is installed in the back side (the rear side of the chassis of the smart phone 700, that is, in the vertical direction relative to the page surface of FIG. 7) of the input screen 703. The input screen 703 is constituted including a flexible material (a resin material or a thin glass plate, for example) which bends when tapped. Then, when the button 705 is tapped strong, a pressure is added to the pressure sensor due to bending of the flexible material. The pressure sensor measures the pressure. The bar of the gauge 706 representing a degree of dissatisfaction is indicated according to a measurement result of the pressure sensor. When tapping of the button 705 is not performed for a while after the input, the input screen 703 is housed in the upper part of the screen. A user's-sense-of-use collection application collects information which has an influence on the user's sense of use assuming that the input of the sense of use has become final. Specifically, the user's-sense-of-use collection application collects the evaluation itself of the sense of use, and environmental information on such as date and time, a location, network quality, other applications which are being executed and the like. Here, the date and time is time information on the measurement environment, and is the date and time when the information processing device 100 has measured the network quality. The location is location information on the measurement environment, and is a place where the information processing device 100 has measured the network quality.

According to this example embodiment, it is possible to accept evaluation of user's sense of use according to an aspect different from that of the second example embodiment.

### The Fifth Example Embodiment

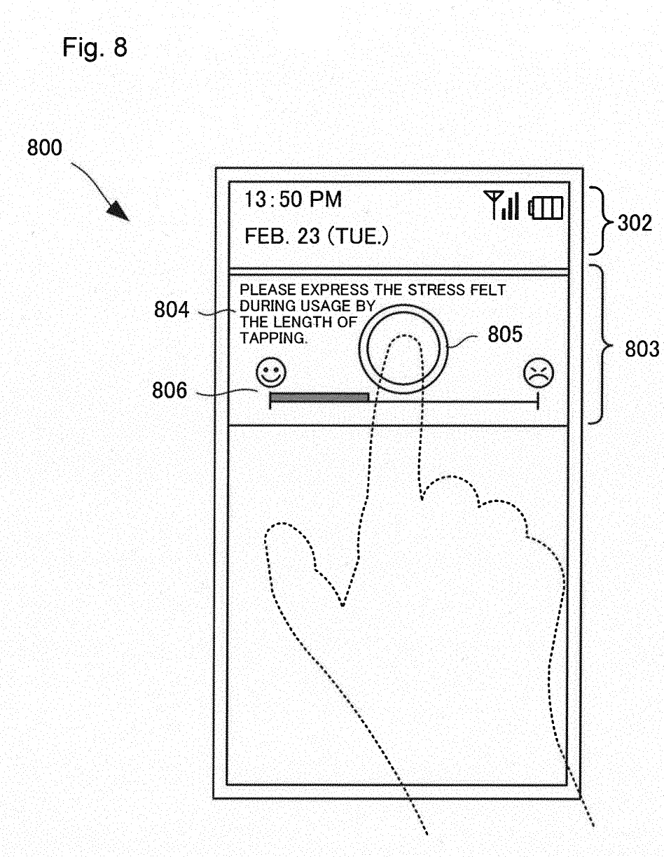

Next, a smart phone according to the fifth example embodiment of the present invention will be described using FIG. 8. FIG. 7 is a diagram illustrating a sense-of-use input screen of a smart phone according to this example embodiment. A smart phone 800 according to this example embodiment is different from a smart phone of the second example embodiment in a point that a sense of use is inputted using a difference in the length of the tapping. Since the structures and operations other than that are similar to those of the second example embodiment, the same codes are attached to the same structures and the operations and detailed description will be omitted.

A button 805 which should be tapped and a message 804 that says “Please express the stress felt during usage by the length of tapping.” are indicated on an input screen 803. The longer tapping of the button 805 is, the longer the bar of a gauge 706 that represents a degree of dissatisfaction is in proportion to the tapping length. When tapping of the button 805 is not performed for a while after the input, the input screen 803 is housed in the upper part of the screen. A user's-sense-of-use collection application collects information which has an influence on the user's sense of use assuming that the input of a sense of use has become final. Specifically, the evaluation itself of the sense of use, and environmental information on such as date and time, a location, network quality, other applications which are being executed and the like are collected.

According to this example embodiment, it is possible to accept evaluation of user's sense of use according to an aspect different from that of the second example embodiment.

### Other Example Embodiments

Systems or devices made by any combination of the separate features included in the respective example embodiments are also included in the category of the present invention.

The example embodiments may be applied to a system including a plurality of devices, or it may be applied to a monolithic device. Furthermore, the present invention is applicable when supplying an information processing program for realizing the functions of the example embodiments directly or remotely to a system or a device. Accordingly, in order to realize the functions of the example embodiments by a computer, a program installed into a computer or a medium storing the program, and a WWW (World Wide Web) server to make the program be download are also included in the category of the present invention. In particular, at least a non-temporary computer readable medium (non-transitory computer readable medium) storing a program that makes a computer execute the processing steps included in the example embodiments mentioned above is included in the category of the present invention.

### Other Expressions of the Example Embodiments

A part or all of the above-mentioned example embodiments can also be described like, but not limited to, the following supplementary notes.

(Supplementary note 1) An information processing device, comprising:

a display means for indicating an image;

a display control means for making the display means display an input screen for inputting a sense of use;

an operation means for accepting operation from a user; and

a memory means for accumulating, taking the user having inputted a sense of use to the operation means in a state that the input screen is being indicated as a trigger, the sense of use having been inputted and environmental information indicating an information processing environment at a time of inputting the user's sense of use.

(Supplementary note 2) The information processing device according to supplementary note 1, further comprising

a touch panel to function as the display means and the operation means, wherein

the input screen is prepared in a notification bar to be indicated from an upper part of the touch panel by flick operation.

(Supplementary note 3) The information processing device according to supplementary note 1 or 2, wherein

the environmental information includes at least one of time, a location, network quality, and an application being executed.

(Supplementary note 4) The information processing device according to supplementary note 1, 2 or 3, wherein

the input screen comprises a plurality of buttons that express user's sense of use step by step.

(Supplementary note 5) The information processing device according to any one of supplementary notes 1 to 4, wherein

the input screen comprises one button for inputting user's sense of use by a number of times of tapping.

(Supplementary note 6) The information processing device according to any one of supplementary notes 1 to 4, wherein

the input screen comprises one button for inputting user's sense of use by strength of tapping.

(Supplementary note 7) The information processing device according to any one of supplementary notes 1 to 4, wherein

the input screen comprises one button for inputting user's sense of use by length of tapping.

(Supplementary note 8) The information processing device according to any one of supplementary notes 1 to 7, further comprising

a transmission means for transmitting the sense of use of a user and the environmental information accumulated in the memory means to a server periodically.

(Supplementary note 9) An information processing method, comprising:

making a display means display an input screen for inputting a sense of use; and

accumulating, taking a user inputting a sense of use to an operation means in a state that the input screen is being indicated, the sense of use having been inputted and environmental information indicating an information processing environment at a time of inputting the user's sense of use.

(Supplementary note 10) A program storing medium storing a program to make a computer execute processing of:

making a display means display an input screen for inputting a sense of use; and

accumulating, taking a user inputting a sense of use to an operation means in a state that the input screen is being indicated, the sense of use having been inputted and environmental information indicating an information processing environment at a time of inputting the user's sense of use.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application claims priority based on Japanese application Japanese Patent Application No. 2016-036277, filed on Feb. 26, 2016, the disclosure of which is incorporated herein in its entirety by reference.

What is claimed is:

1. An information processing device, comprising:
a display unit indicating an image;
a display control unit making the display means display an input screen for inputting a sense of use;
an operation unit accepting operation from a user; and
a memory unit accumulating, taking the user having inputted a sense of use to the operation unit in a state that the input screen is being indicated as a trigger, the sense of use having been inputted and environmental information indicating an information processing environment at a time of inputting the user's sense of use.

2. The information processing device according to claim 1, further comprising
a touch panel to function as the display unit and the operation unit, wherein
the input screen is prepared in a notification bar to be indicated from an upper part of the touch panel by flick operation.

3. The information processing device according to claim 1, wherein
the environmental information includes at least one of time, a location, network quality, and an application being executed.

4. The information processing device according to claim 1, wherein
the input screen comprises a plurality of buttons that express user's sense of use step by step.

5. The information processing device according to claim 1, wherein
the input screen comprises one button for inputting user's sense of use by a number of times of tapping.

6. The information processing device according to claim 1, wherein
the input screen comprises one button for inputting user's sense of use by strength of tapping.

7. The information processing device according to claim 1, wherein
the input screen comprises one button for inputting user's sense of use by length of tapping.

8. The information processing device according to claim 1, further comprising
a transmission unit transmitting the sense of use of a user and the environmental information accumulated in the memory unit to a server periodically.

9. An information processing method, comprising:
making a display unit display an input screen for inputting a sense of use; and
accumulating, taking a user inputting a sense of use to an operation unit in a state that the input screen is being indicated, the sense of use having been inputted and environmental information indicating an information processing environment at a time of inputting the user's sense of use.

10. A program storing medium storing a program to make a computer execute processing of:
making a display unit display an input screen for inputting a sense of use; and
accumulating, taking a user inputting a sense of use to an operation unit in a state that the input screen is being indicated, the sense of use having been inputted and environmental information indicating an information processing environment at a time of inputting the user's sense of use.
